(19) United States
(12) Patent Application Publication
(10) Pub. No.: US 2013/0240163 A1
(43) Pub. Date: Sep. 19, 2013

(54) AIRCRAFT DOOR FRAME LINING FOR VISUALLY COVERING A DOOR AREA IN AN AIRCRAFT

(71) Applicant: AIRBUS OPERATIONS GMBH, Hamburg (DE)

(72) Inventors: Michael Mosler, Plaisance du Touch (FR); Jovan Ulbrich-Gasparevic, Pinneberg (DE)

(21) Appl. No.: 13/870,035

(22) Filed: Apr. 25, 2013

Related U.S. Application Data
(63) Continuation of application No. PCT/EP2011/069812, filed on Nov. 10, 2011.
(60) Provisional application No. 61/413,112, filed on Nov. 12, 2010.

(30) Foreign Application Priority Data
Nov. 12, 2010 (DE) 10 2010 051 217.6

(51) Int. Cl. B64C 1/14

(52) U.S. Cl. CPC B64C 1/1461
USPC 160/238; 160/368.1; 160/405

(57) ABSTRACT

A lining of aircraft door frames and a door frame lining above an aircraft door is provided. The upper door frame lining in turn includes a first component designed for visually covering the door area. Complete visual covering of the door area is possible. The first component is designed for attachment above the aircraft door and is designed for mechanical affixation to the primary structure of the aircraft.

### CROSS REFERENCE TO RELATED APPLICATIONS

This is a continuation of International Application No. PCT/EP2011/069812, filed Nov. 10, 2011, which application claims priority to U.S. Provisional Patent Application No. 61/413,112, filed on Nov. 12, 2010 and to German Patent Application No. 10 2010 051 217.6, filed on Nov. 12, 2010, which are incorporated herein by reference in their entirety.

### TECHNICAL FIELD

The technical field relates to aircraft interior architecture. In particular, the technical field relates to an aircraft door frame lining for visually covering a door area in an aircraft, to an aircraft interior architecture, to a method, and to an aircraft.

### BACKGROUND

The visual improvement of aircraft interior architecture increasingly forms part of the requirement of airlines, with which requirements aircraft manufacturers are confronted. Apart from, for example, maximizing the overhead space in passenger areas, visually pleasing surfaces and surface flows in the interior of an aircraft form parts of the aspects of an interior architecture, which aspects may ensure a special sense of well-being in passengers.

In particular on long-haul flights, where passengers have sleep phases or rest phases, a reduction in the brightness of light sources in the aircraft interior may be desirable. Thus, increasingly, attention is paid to indirect illumination in the aircraft interior architecture and to darkening or shielding bright light sources in the aircraft interior.

In addition, other objects, desirable features and characteristics will become apparent from the subsequent summary and detailed description, and the appended claims, taken in conjunction with the accompanying drawings and this background.

### SUMMARY

Accordingly, the present disclosure provides visual enhancement of an aircraft interior architecture.

The exemplary embodiments described equally relate to the aircraft door frame lining, the aircraft interior architecture, the method and the aircraft. In other words, characteristics which below are described with reference to, for example, the aircraft door frame lining can also be implemented in the aircraft interior architecture and in the aircraft and vice versa.

According to an exemplary embodiment of the present disclosure, an aircraft door frame lining for visually covering a door area in an aircraft is stated. The aircraft door frame lining comprises an upper door frame lining, wherein the upper door frame lining comprises a first component. The first component is designed for attachment above an aircraft door, and the first component is designed for visually covering the door area.

The aircraft door frame lining is designed for lining a door within the fuselage of the aircraft.

In other words, the door to be covered is situated in the fuselage of the aircraft rather than in the interior of the aircraft.

In this arrangement the aircraft door frame lining is designed as a permanently installed part of the interior architecture of the aircraft. In other words, the aircraft door frame lining forms an integral part of the interior architecture.

In other words, an aircraft interior architecture is stated that comprises a permanently installed upper door frame lining with a first component. This first component is affixed above an aircraft door, and the first component is designed for visually covering the door area.

For example, the first component may comprise a length such that a width of the door area (or even a longer distance) can be spanned. In this arrangement visual covering can either take place by means of the first component itself, or by means of a medium, for example by means of a curtain or a roller blind that is additionally affixed to the first component.

The aircraft door frame lining is designed in such a manner that by means of a curtain or a roller blind the door area of the aircraft may be completely covered.

Thus, an aircraft interior architecture may be provided by means of which during the flight the door entrance area can be covered with the use of, for example, a curtain, and thus the door entrance area is visually enhanced and an inviting ambiance may be created.

Advantageously, the present disclosure may be simple to handle because the aircraft door frame lining forms a permanently installed part of the aircraft interior architecture, and thus no separate design space is required.

Hereinafter, the term “aircraft door frame lining” may be used synonymously with the term “door frame lining”.

According to another exemplary embodiment of the present disclosure, the first component is designed in such a manner that attachment of the first component above the door to a primary structure of the aircraft becomes possible.

In other words, the length of the first component is such that attachment points of the first component can be affixed to the primary structure of the aircraft.

In other words, this exemplary embodiment of the present disclosure differs from the merely temporary, detachable affixation of a visual barrier on the aircraft door surface in that the present disclosure states a permanently installed interior architecture with the aircraft door frame lining, wherein the aforesaid is attached to the primary structure of the aircraft. Thus, the door frame lining may carry greater loads because load introduction, for example of the weight of a roller blind above the aircraft door frame lining, takes place up to the primary structure of the aircraft.

Affixation of the aircraft door frame lining to the primary structure of the aircraft can take place by means of the principle of “lining-bracket-primary structure”. In this arrangement the door frame lining is screwed with the use of holders (brackets) to the primary structure, in most cases by means of screws. However, other fasteners are also possible. In this manner a high strength of the door frame lining may be obtained because it is connected to the primary structure.

According to another exemplary embodiment of the present disclosure, the first component is a curtain rail.

As is, for example, shown in FIGS. 1 to 4, the curtain rail is connected above a door area to the aircraft primary structure. By means of a curtain that is present in a separately provided stowage compartment of the aircraft door frame lining, at any desired point in time the door area of the aircraft can be visually covered. Apart from simple handling, this provides a stowage space for the curtain, which is in this case not in the way of the aircraft crew. This corresponds to a visually pleasing solution, and no additional stowage space, for example in the hatrack, may be required.

According to an exemplary embodiment of the present disclosure, the aircraft door frame lining further comprises a lateral door frame lining, wherein the lateral door frame lining comprises a first volume for the stowage of a curtain.

In this arrangement the lateral door frame lining as well as the upper door frame lining forms an integral part of the interior architecture of the aircraft interior.

According to an exemplary embodiment the aircraft door frame lining is made from a plastic material.

Furthermore, the lateral door frame lining can also be referred to as the “lateral lining”. For example, the first volume can be provided by means of a flap behind which there is an intermediate area between the interior architecture and the aircraft primary structure. If it is not desirable to make it possible to see the aircraft primary structure, for example the frame elements for opening the flaps, according to an exemplary embodiment of the present disclosure the design as an interior-lined compartment for providing the first volume is provided.

According to an exemplary embodiment of the present disclosure, the lateral door frame lining is designed as a re-closable compartment for providing the first volume.

In this arrangement, on the compartment a lock can be in place for the purpose of securing the compartment. By way of an articulated connection the compartment can comprise a rotatably held door behind which, for example, the curtain can be stowed. This can further increase the space saving achieved by means of an exemplary embodiment of the present disclosure.

According to this exemplary embodiment of the present disclosure, horizontal stowage of a curtain on the curtain rail within the re-closable compartment may be made possible. If desired, likewise, a curtain can be provided, wherein by means of a horizontal movement of the curtain complete stowage in the lateral door frame lining can take place.

According to an exemplary embodiment of the present disclosure, the lateral door frame lining comprises an opening. Furthermore, the curtain rail extends through the opening, and consequently, for attachment, the curtain rail is to be connected to the primary structure of the aircraft.

In other words, the lateral door frame lining comprises a region in which the curtain rod or curtain rail extends through the lateral door frame lining. In this arrangement the lateral door frame lining is arranged in such a manner that when the curtain rail is passed through it, said curtain rail can be made to connect the aircraft primary structure for attachment.

According to an exemplary embodiment of the present disclosure, the curtain rail comprises a slider for accommodating a curtain. Furthermore, the curtain rail is attached to the aircraft door frame lining in such a manner that the slider projects in horizontal direction from the curtain rail.

In other words, the slider is arranged between the rail and the interior or passenger compartment of the aircraft. Said slider thus does not point from the curtain rail to the floor of the aircraft, but instead it points horizontally and laterally forwards. The connecting region through which the curtain is affixed to the slider is not situated between the rail and the floor, but instead frontally or horizontally in front of the rail.

In other words, the curtain is guided in front of the curtain rail. In contrast to conventional curtain guides there is no gap between the curtain rail and the curtain.

According to an exemplary embodiment the curtain rail is completely covered by the installed curtain. This may make a further contribution to providing a visually pleasing solution for covering the door entrance area.

According to an exemplary embodiment of the present disclosure, the aircraft door frame lining comprises a curtain, wherein the curtain rail and the curtain are interconnected in such a manner that in its installed state the curtain covers the curtain rail.

According to an exemplary embodiment of the present disclosure, the curtain comprises a reinforced connecting area.

In this arrangement the connecting area can be designed for affixation of the curtain to the slider.

By means of this exemplary embodiment, due to the reinforced connecting area in the curtain, the latter can be guided horizontally in front of the curtain rail so that said curtain completely covers the curtain rail. There is thus no visual gap between the curtain and the curtain rail.

According to an exemplary embodiment of the present disclosure, the first component of the upper door frame lining is a second volume for the stowage of a roller blind.

In other words, the second volume is designed for the stowage of a roller blind. This may make it possible to visually cover the door area within the aircraft interior, for example by pulling the roller blind out of the second volume. In other words, vertical stowage of the roller blind is made possible by means of the second volume. In vertical direction it is thus possible to pull the roller blind from the second volume above the aircraft door in the direction of the floor. In this case, too, the second volume forms an integral part of the interior architecture of the aircraft.

In this and in any other exemplary embodiment the term “roller blind” may relate to any covering device that fulfils the task of providing a visual cover of the door area.

For example, the first component can additionally be designed to roll the roller blind on or off by means of a rotation mechanism.

According to another exemplary embodiment of the present disclosure, the first component is designed as a compartment within the aircraft door frame lining that is arranged above the aircraft door.

According to an exemplary embodiment of the present disclosure, the first component comprises an outlet opening, wherein the outlet opening makes it possible for a roller blind to be reversibly pulled out.

According to one exemplary embodiment of the present disclosure, the aircraft door frame lining comprises at least one locking point, wherein the locking point is designed to lock a roller blind.

As shown, for example, in FIG. 7, in this manner a roller blind that above the aircraft door forms an integral part of the aircraft interior can be permanently attached in the floor area.

According to one exemplary embodiment of the present disclosure, the locking point is situated in a floor area of the aircraft door frame lining.

According to one exemplary embodiment of the present disclosure, an aircraft interior architecture comprising an aircraft door frame lining according to a preceding or following exemplary embodiment is stated.

According to one exemplary embodiment of the present disclosure, an aircraft comprising an aircraft door frame lining according to any one of the preceding or following exemplary embodiments is stated.

According to one exemplary embodiment of the present disclosure, a method for visually covering a door area in an aircraft is stated, wherein the method comprises the following: providing an upper door frame lining that forms a permanent part of an aircraft interior architecture, wherein the upper door frame lining is designed for guiding a medium, for example a roller blind or a curtain; positioning the medium along the upper door frame lining, which results in visual covering of the door area in an aircraft.

According to one exemplary embodiment of the present disclosure, by means of the aircraft door frame lining a method for visually covering the door area of the aircraft is provided, which method comprises the following: providing a curtain of a lateral door frame lining; positioning the curtain along a curtain rod that forms part of the upper door frame lining, which results in complete visual covering of a door area in an aircraft.

According to an exemplary embodiment of the present disclosure, by means of the aircraft door frame lining a method for visually covering the door area of the aircraft is provided, which method comprises the following: providing an upper door frame lining that has been affixed above an aircraft door, wherein the upper door frame lining forms part of an integral permanent aircraft interior architecture; pulling a roller blind in vertical direction from the upper door frame lining, which results in complete visual covering of a door area of an aircraft door.

It may be considered to be a fundamental idea of the present disclosure to provide a permanently installed upper door frame lining along which a medium, for example a roller blind or a curtain, can be guided. Furthermore, for guiding along the upper door frame lining this medium is brought into position within the aircraft door frame lining so that, if desired, the curtain or the roller blind can be moved and guided along the door frame lining in such a manner that visual covering of the door area in an aircraft takes place. Since both the upper door frame lining and the roller blind or the curtain form an integral part of the aircraft interior architecture, they need not be dismantled, remounted or stowed at other locations within the aircraft.

A person skilled in the art can gather other characteristics and advantages of the disclosure from the following description of exemplary embodiments that refers to the attached drawings, wherein the described exemplary embodiments should not be interpreted in a restrictive sense.

### BRIEF DESCRIPTION OF THE DRAWINGS

The various embodiments will hereinafter be described in conjunction with the following drawing figures, wherein like numerals denote like elements, and wherein:

FIG. 1 to FIG. 3 show diagrammatic two-dimensional views of an aircraft door frame lining according to an exemplary embodiment of the present disclosure.

FIG. 4 shows a diagrammatic two-dimensional view of a curtain rail as part of an aircraft door frame lining according to an exemplary embodiment of the present disclosure.

FIG. 5 to FIG. 7 show diagrammatic two-dimensional views of a door frame lining according to a further exemplary embodiment of the present disclosure.

FIG. 8 shows an aircraft comprising a door frame lining according to an exemplary embodiment of the present disclosure.

FIG. 9 shows a flow chart of a method according to a further exemplary embodiment of the present disclosure.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

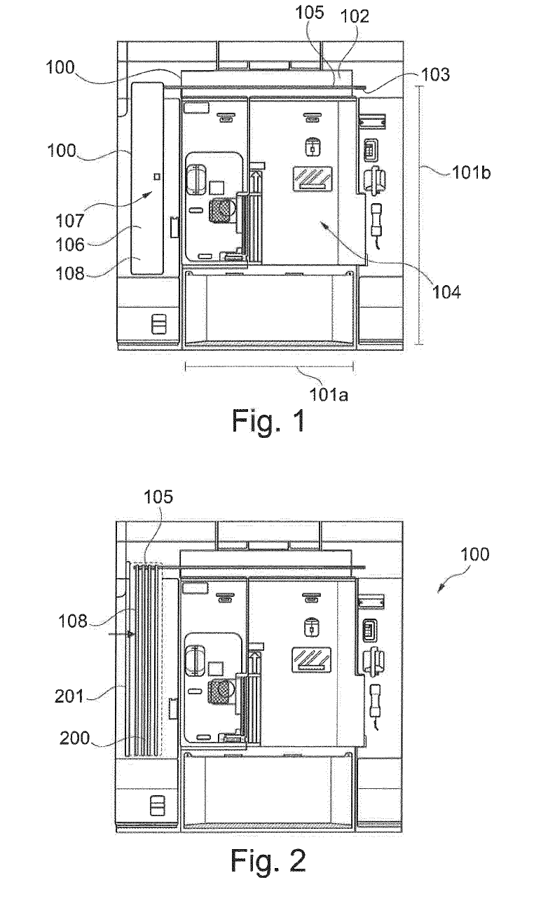

FIG. 1 shows an aircraft door frame lining 100 for visually covering a door area 101A and 101B in an aircraft. In this arrangement the aircraft door frame lining comprises an upper door frame lining 102 with a first component 103. In this arrangement the first component is attached above the aircraft door 104 of the aircraft interior architecture shown. Furthermore, the first component 103 is designed for visually covering the door area. In the exemplary embodiment shown in this figure the first component is designed as a curtain rail 105. Furthermore, in FIG. 1 a lateral door frame lining 106 is shown that provides a first volume 107 for the stowage of a curtain. The lateral door frame lining is designed as a re-closable compartment 108 for providing the first volume.

The lateral door frame lining further comprises an opening (not shown), wherein the curtain rail extends through the opening, which results in the curtain rail being able to be connected to the primary structure of the aircraft (not shown) for attachment.

In other words, the curtain rail is designed in such a manner that attachment of the curtain rail above the aircraft door 104 to the primary structure of the aircraft can take place. This can ensure that the first component bears the weight force of, for example, a roller blind or a curtain and introduces this load into the primary structure. In other words, the first component is designed for introducing the load of a roller blind or of a curtain into the primary structure of the aircraft. In this arrangement in FIG. 1 the aircraft door frame lining is shown in a first state, in which the curtain (not drawn in the figure) is still accommodated in the lateral door frame lining 106 that extends perpendicularly to the upper door frame lining.

FIG. 2 shows the exemplary embodiment of FIG. 1 in a second state, in which the curtain 200 is visible. In this arrangement the door 201 of the compartment 108 in which the curtain can be accommodated for stowage is shown in its open position. In this arrangement the upper area of the compartment 108 shows that the curtain rod 105 extends into the compartment 108 and through an opening (not shown in the drawing) leads behind the compartment to the primary structure.

FIG. 3 shows the aircraft door frame lining of FIGS. 1 and 2 in a further, third, state. In this arrangement the aircraft door frame lining 100 is shown with an upper door frame lining 102 and a lateral door frame lining 106. The illustration clearly shows that the curtain 200 visually covers the entire door area with the width 101A and the height 101B. In this manner it is possible to achieve a visually pleasing design of the aircraft interior architecture. Moreover, according to the exemplary embodiment of FIGS. 1 and 3 simple handling is ensured because by means of moving the curtain in horizontal direction from a storage compartment integrally integrated in the aircraft interior architecture complete covering is possible. No stowage space, for example in a hatrack, is required for covering the door area.

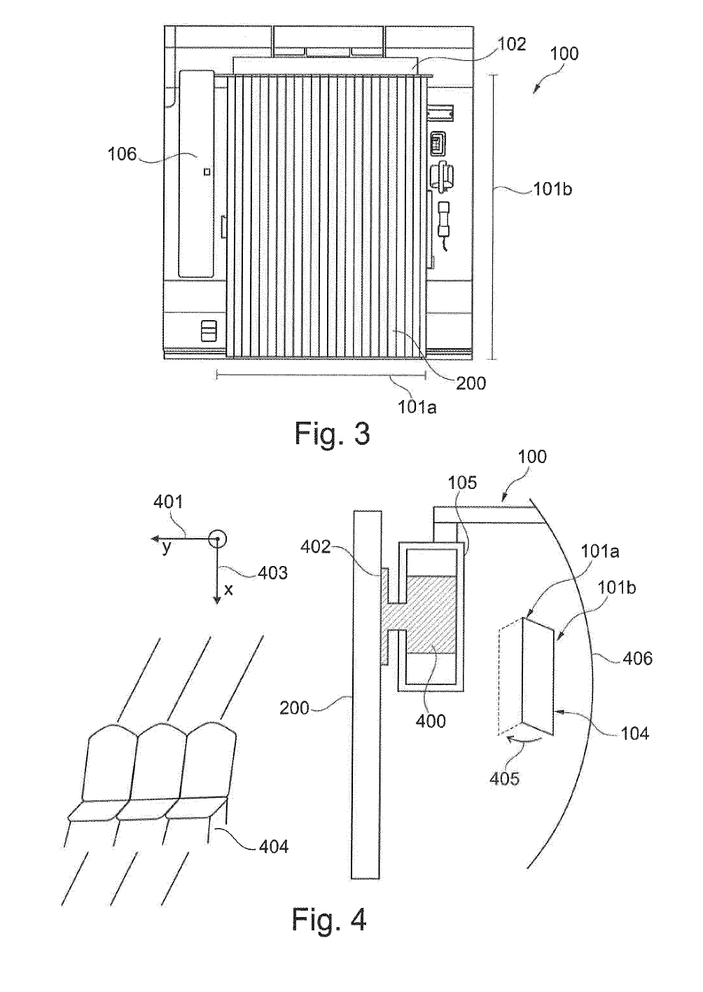

FIG. 4 shows a curtain rail 105 with a slider 400 and a curtain 200 attached thereto, wherein the aforesaid can be integrated in an exemplary embodiment of an aircraft door frame lining according to the present disclosure. As an example, the aircraft fuselage 406 is shown in which there is an aircraft door 104 that can be opened as indicated by the arrow 405. For visually separating this door area 101A and 101B an aircraft door frame lining 100 is provided that is attached to the primary structure of the aircraft (in the illustration as an example represented by the fuselage 406). In this arrangement FIG. 4 shows that the slider 400 is arranged within the curtain rail 105 in such a manner that the curtain 200 extends in front of the curtain rail 105 and is thus located in horizontal direction 401 spaced apart from the curtain rail. In this manner an arrangement can be achieved in which the curtain 200 completely covers the curtain rail 105 from the view of passengers in the passenger area 404.

The curtain shown in the illustration comprises a reinforced connecting area 402 so that affixation, as described above, of the curtain to the slider 400 in front of the curtain rail is made possible.

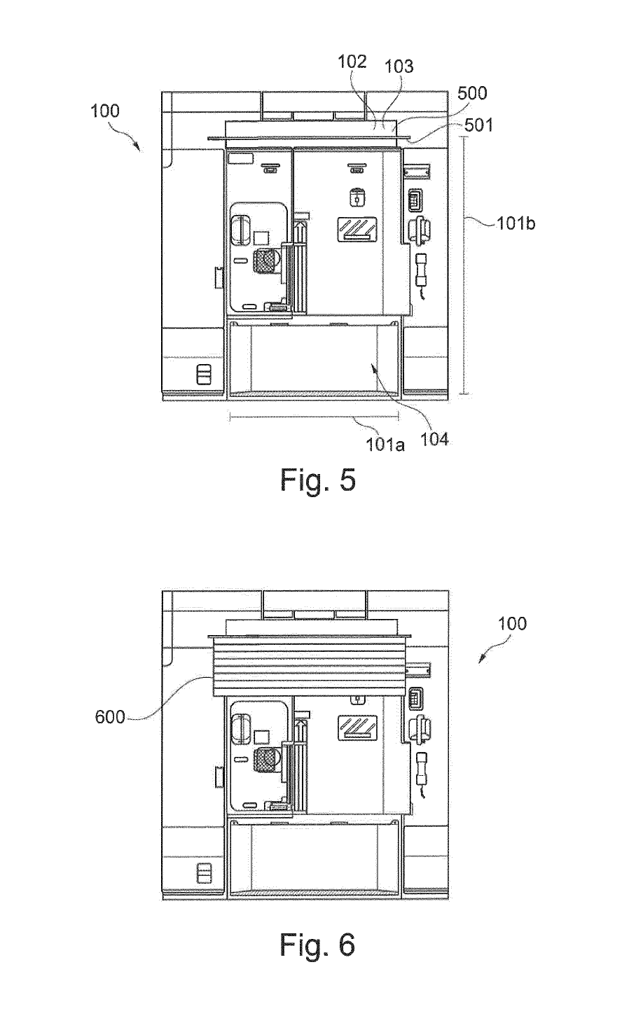

FIG. 5 shows a further exemplary embodiment of the present disclosure, in which an aircraft door frame lining 100 is shown which comprises a second volume 501 for the stowage of a roller blind 600 (see FIG. 6). Also shown is an upper door frame lining 102, which forms an integral part of the aircraft interior architecture shown. In this arrangement the upper door frame lining comprises a first component 103, which is attached above the aircraft door. In conjunction with the following FIGS. 6 and 7 it becomes clear that the first component is designed for visually covering the door area 101A and 101B.

The second volume shown in the illustration is arranged as a coffer or box above the door and comprises an outlet opening 501 that makes it possible to reversibly pull out the roller blind 600 (see FIG. 6).

FIG. 6 shows the aircraft door frame lining 100 of FIG. 5 in a second state, in which the roller blind 600 has already been pulled out in vertical direction. In this manner continuous covering of the surface of the door area can be achieved as desired.

FIG. 7 shows the exemplary embodiment of the aircraft door frame lining 100 of FIGS. 5 and 6 in a completely closed third state. In this arrangement the roller blind 600, which is situated in the first component, has been completely pulled out of the outlet opening 501. Furthermore, the roller blind 600 is affixed at locking points 700 that are situated in a floor area 701 of the aircraft door frame lining.

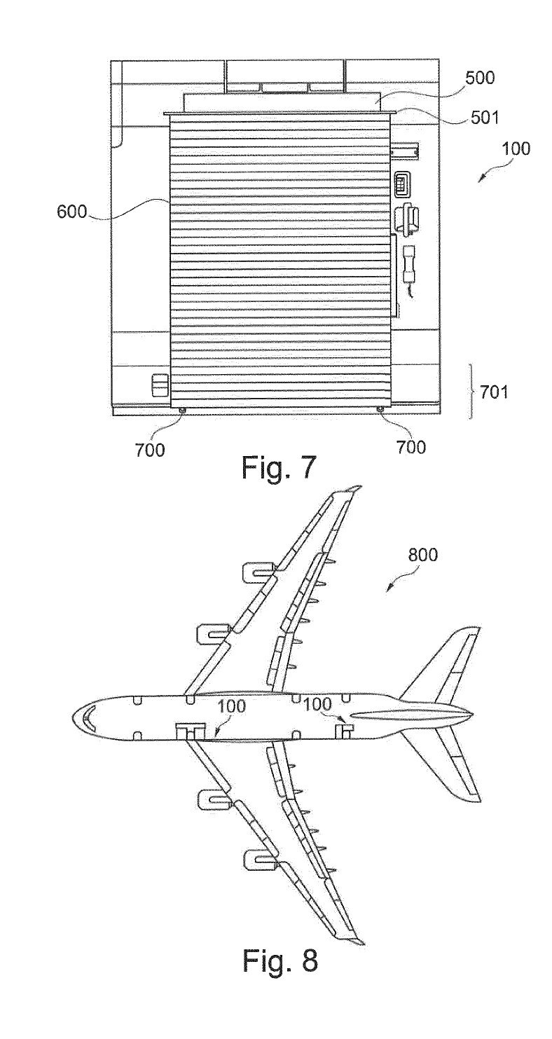

FIG. 8 shows an aircraft 800 according to a further exemplary embodiment of the present disclosure, wherein the aircraft comprises two aircraft door frame linings 100.

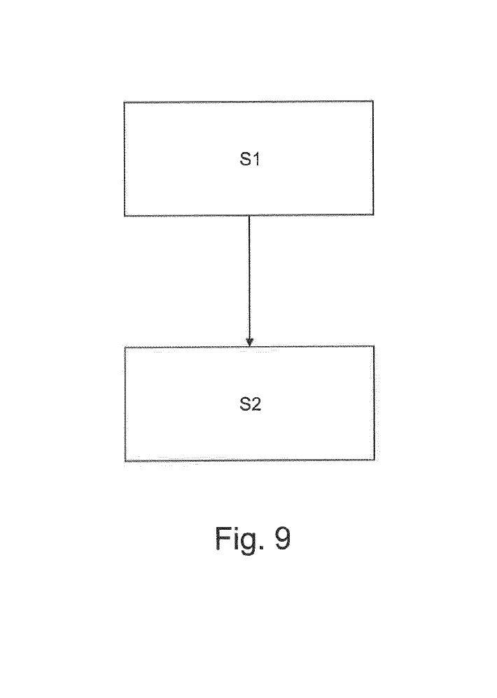

FIG. 9 shows a flow chart of a method according to a further exemplary embodiment of the present disclosure. The method comprises providing an upper door frame lining that forms an integral part of an aircraft interior architecture. This is designated S1. In this arrangement the upper door frame lining is designed for guiding a medium, for example a roller blind or a curtain. Positioning the medium along the upper door frame lining, which results in visually covering the door area in an aircraft, is designated S2.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

1. An aircraft door frame lining for visually covering a door area in an aircraft, with the aircraft door frame lining comprising:
an upper door frame lining including a first component attachment above an aircraft door,
wherein the first component is designed for visually covering the door area.

2. The aircraft door frame lining of claim 1,
wherein the first component is coupled above the door to a primary structure of the aircraft.

3. The aircraft door frame lining of claim 1,
wherein the first component is a curtain rail.

4. The aircraft door frame lining of claim 3, with the aircraft door frame lining further comprising:
a lateral door frame lining,
wherein the lateral door frame lining comprises a first volume for the stowage of a curtain.

5. The aircraft door frame lining of claim 4,
wherein the lateral door frame lining comprises a re-closable compartment for providing the first volume.

6. The aircraft door frame lining of claim 5,
wherein the lateral door frame lining comprises an opening, and
wherein the curtain rail extends through the opening, such that, for attachment, the curtain rail is connected to the primary structure of the aircraft.

7. The aircraft door frame lining of claim 3,
wherein the curtain rail comprises a slider for accommodating a curtain,
wherein the curtain rail is attached to the aircraft door frame lining in such a manner that the slider projects in horizontal direction from the curtain rail.

8. The aircraft door frame lining of claim 3, with the aircraft door frame lining further comprising:
a curtain,
wherein the curtain rail and the curtain are interconnected in such a manner that in its installed state the curtain covers the curtain rail.

9. The aircraft door frame lining of claim 8,
wherein the curtain comprises a reinforced connecting area.

10. The aircraft door frame lining of claim 1,
wherein the first component comprises a second volume for the stowage of a roller blind.

11. The aircraft door frame lining of claim 1,
wherein the first component comprises an outlet opening, and
wherein the outlet opening makes it possible for a roller blind to be reversibly pulled out.

12. The aircraft door frame lining of claim 1, with the aircraft door frame lining further comprising:
at least one locking point, and
wherein the locking point is designed to lock a roller blind.

13. A method for visually covering a door area in an aircraft, wherein the method comprises:
providing an upper door frame lining that forms a permanent part of an aircraft interior architecture, the upper door frame lining designed for guiding a medium; and
positioning the medium along the upper door frame lining, which results in visual covering of the door area in an aircraft.

14. An aircraft interior architecture, comprising:
an aircraft door frame lining for visually covering a door area in an aircraft that includes an upper door frame lining having a first component that attaches above an aircraft door to a primary structure of the aircraft,
wherein the first component is designed for guiding a medium to visually cover the door area.

15. An aircraft comprising:
an aircraft door frame lining for visually covering a door area of the aircraft, the door frame lining including an upper door frame lining having a first component that attaches above an aircraft door to a primary structure of the aircraft,
wherein the first component guides a curtain or a roller blind to visually cover the door area.

16. The method of claim 13, wherein the medium is a roller blind.

17. The method of claim 13, wherein the medium is a curtain.

18. The aircraft interior architecture of claim 14, wherein the medium is a curtain and the aircraft door frame lining further comprises:
a lateral door frame lining,
wherein the lateral door frame lining comprises a first volume for the stowage of the curtain.

19. The aircraft interior architecture of claim 14, wherein the medium is a roller blind and the first component comprises an outlet opening from which the roller blind is reversibly pulled out.

20. The aircraft interior architecture of claim 14, wherein the first component comprises a second volume for the stowage of a roller blind.
